(19) United States
(12) Patent Application Publication
(10) Pub. No.: US 2017/0295725 A1
(43) Pub. Date: Oct. 19, 2017

(54) GARDENING BARRIER

(71) Applicant: Landecor, LLC, Lehi, UT (US)

(72) Inventors: Bryce Doman, Lehi, UT (US); Verl Doman, Cedar Hills, UT (US)

(73) Assignee: Landecor, LLC, Lehi, UT (US)

(21) Appl. No.: 15/439,906

(22) Filed: Feb. 22, 2017

Related U.S. Application Data
(63) Continuation of application No. 14/799,561, filed on Jul. 14, 2015, now abandoned.
Application No. 14/799,561 is a continuation of application No. 13/170,034, filed on Jun. 27, 2011, now abandoned.
(60) Provisional application No. 61/359,244, filed on Jun. 28, 2010.

(51) Int. Cl. A01G 1/08

(52) U.S. Cl. CPC A01G 1/08

(57) ABSTRACT

A gardening barrier system and associated methods is disclosed. The system may include molded panels made from an aggregate material. Each panel may have a display side with a façade resembling a wall of vertically stacked and offset pieces of wall building materials and a protrusion at an end of the panel resembling an offset piece of the wall and the wall building materials. The protrusion can include a rounded end to allow adjacent panels to be assembled at an infinitely adjustable angle relative to one another. The protrusion can be sized to minimize a gap between adjacent panels and the rounded end can be sized to approximate a size of a rounded edge of the wall building materials of the façade to minimize an appearance of a transition between adjacent panels.

### PRIORITY DATA

This application is a continuation of U.S. patent application Ser. No. 14/799,561, filed Jul. 14, 2015, which is a continuation of U.S. patent application Ser. No. 13/170,034, filed Jun. 27, 2011, which claims the benefit of U.S. Provisional Application Ser. No. 61/359,244 filed Jun. 28, 2010, each of which are incorporated by reference herein.

### FIELD OF THE INVENTION

The present invention relates generally to gardening barrier devices and associated methods. Accordingly, the present invention involves the mechanical arts field.

### BACKGROUND OF THE INVENTION

Often in landscaping, a gardening barrier will be used to support soil, rocks, or other types of earth, for example, as a planter bed or a retaining wall. It is common for such devices to not only provide a structural function, but an aesthetic one as well. These structures have traditionally been made with wall building materials, including natural materials such as rock, wood, brush, or thatch, and man-made materials such as brick. Often, structures constructed of rock, brick, or wood have a mortar material that binds individual pieces together to give strength to the structure. Traditional wall building materials can be arranged in a limitless number of ways to achieve not only an effective gardening barrier structure, but also an aesthetically appealing design. Thus, such gardening barriers are often desired to enhance the visual appeal of a landscape design. However, gardening barriers made of these materials may be difficult, time intensive or expensive to construct and further may require a degree of skill and craftsmanship that is beyond that of many people.

### SUMMARY OF THE INVENTION

Modern advances in construction technology have resulted in new materials that can be used to construct gardening barriers. The new, non-traditional materials can be used to create effective gardening barrier structures with less expense and with greater ease than before. What modern materials may lack, however, is the aesthetic appeal of the traditional wall building materials. Thus, the present inventor has recognized a need for a gardening barrier that has the aesthetic appeal of traditional wall building materials and the low cost and ease of construction that may be found in a modern construction material.

Accordingly, the present invention provides a gardening barrier system and associated methods thereof. In one aspect, for example, a gardening barrier system is provided. Such a system may include a plurality of molded panels made from an aggregate material, each panel having a display side with a façade resembling a wall of vertically stacked and offset pieces of one or more wall building materials and the one or more wall building materials, and a protrusion at an end of the panel resembling an offset piece of the wall, the protrusion including a vertical shaft such that, when assembled, the protrusion of a first of the plurality of panels vertically overlaps the protrusion of a second of the plurality of panels with the vertical shafts aligned to form a connecting shaft extending substantially the entire height of the plurality of panels. The protrusion can include a rounded end oriented substantially parallel to an axis of the vertical shaft to allow adjacent panels to be assembled at an infinitely adjustable angle relative to one another about the axis, wherein the protrusion is sized to minimize a gap between adjacent panels and the rounded end is sized to approximate a size of a rounded edge of the one or more wall building materials of the façade to minimize an appearance of a transition between adjacent panels. The system can further include a connecting rod that, when assembled, extends through the connecting shaft, vertically transversing the overlapping protrusions, and secures the plurality of panels together. In some aspects the connecting rod may also secure the gardening barrier system to a ground surface.

In one aspect, the panel has a thickness perpendicular to the display side and the rounded end of the protrusion substantially spans the thickness of the panel. In another aspect, the protrusion has a thickness perpendicular to the display side and the rounded end of the protrusion substantially spans the thickness of the protrusion. In a further aspect, the panel has a height to thickness ratio of between about 6:1 and about 20:1.

In some aspects of the present invention, the wall building materials include a natural material, or elements resembling a natural material. In a specific aspect, the natural material is selected from the group consisting of rock, wood, grass, and brush. Rock can include, for example, natural forms or man-made forms such as shaped, cut, or quarried stone. In a further aspect the wall building materials may include man-made building materials, or elements resembling a man-made building material, such as bricks, tile, or concrete sections. In another aspect, the façade includes a design depicting a mortar material between the pieces of one or more wall building materials. In some additional aspects, the plurality of molded panels each further comprise a back side. In a specific aspect, the back side includes a façade resembling a wall of vertically stacked and offset pieces of one or more wall building materials. In a more particular aspect, the vertically stacked and offset pieces of the back side correspond to the vertically stacked and offset pieces of the display side. In another aspect, the back side can be devoid of a façade and can have, for example, a smooth or blank surface. In a further aspect, the connecting rod comprises rebar. In yet another aspect, two of the plurality of molded panels are coplanar with each other when assembled. In still another aspect, an angle between two of the plurality of molded panels is less than or equal to 180 degrees when assembled. In still another aspect, the angle between two of the plurality of molded panels is greater than 180 degrees when assembled.

In one aspect, an angle between two of the plurality of molded panels is between about 60 degrees and about 300 degrees when assembled. In a particular aspect, the angle between two of the plurality of molded panels is between about 80 degrees and about 280 degrees when assembled. In a more particular aspect, the angle between two of the plurality of molded panels is between about 90 degrees and about 270 degrees when assembled.

In another aspect of the present invention, a gardening barrier system comprises a first molded panel and a second molded panel, each made from an aggregate material and each panel having a display side with a façade resembling a wall of vertically stacked and offset pieces of rock arranged in a plurality of layers, and a protrusion at an end of the panel resembling an offset piece of rock in one of the plurality of layers of the wall, the protrusion including a vertical shaft such that, when assembled, the protrusion of the first molded panel vertically overlaps the protrusion of the second molded panel with the vertical shafts aligned to form a connecting shaft extending the entire height of the first molded panel and the second molded panel, the protrusion including a rounded end oriented substantially parallel to an axis of the vertical shaft to allow adjacent panels to be assembled at an infinitely adjustable angle relative to one another about the axis, wherein the protrusion is sized to minimize a gap between adjacent panels and the rounded end is sized to approximate a size of a rounded edge of the rock of the façade to minimize an appearance of a transition between adjacent panels, and a connecting rod that, when assembled, extends through the connecting shaft, vertically transversing the overlapping protrusions, and secures the first molded panel and the second molded panel together and secures the gardening barrier system to a ground surface.

In some aspects of the present invention, the façade includes a design depicting a mortar material between the pieces of rock or cut stone. In other aspects, an angle between the first molded panel and the second molded panel is less than or equal to 180 degrees when assembled. In one aspect, an angle between the first molded panel and the second molded panel is between about 60 degrees and about 300 degrees when assembled.

The present invention additionally provides a method of assembling a gardening barrier. Such a method may include positioning a first protrusion at an end of a first molded panel to overlap a second protrusion at an end of a second molded panel, the first molded panel and the second molded panel each having a display side with a façade resembling a wall of vertically stacked and offset pieces of one or more wall building materials, and the first protrusion and the second protrusion each resembling an offset piece of the wall, the first protrusion and the second protrusion each including a rounded end oriented substantially parallel to an axis of a vertical shaft of the first protrusion and second protrusion, respectively, to allow adjacent panels to be assembled at an infinitely adjustable angle relative to one another about the axis, wherein the protrusion is sized to minimize a gap between adjacent panels and the rounded end is sized to approximate a size of a rounded edge of the one or more wall building materials of the façade to minimize an appearance of a transition between adjacent panels, aligning the vertical shaft of the first protrusion and the vertical shaft of the second protrusion to form a connecting shaft extending the entire height of the first panel and the second panel, and disposing a connecting rod in the connecting shaft such that the connecting rod vertically transverses the overlapping first protrusion and second protrusion to secure the first molded panel to the second molded panel and to form a gardening barrier.

In one aspect of the present invention, the method includes securing the gardening barrier to a ground surface with the connecting rod. In another aspect of the present invention, the method includes disposing soil proximate to a back side of the first molded panel. In yet another aspect, the method includes positioning the first molded panel and the second molded panel at a predetermined angle relative to each other. In a specific aspect, the predetermined angle is less than or equal to 180 degrees. In another specific aspect, the predetermined angle is greater than 180 degrees. In one aspect, the predetermined angle is between about 60 degrees and about 300 degrees.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a perspective view of a gardening barrier system from a display side, in accordance with an embodiment of the present invention.

FIG. 2 is a view of the gardening barrier system of FIG. 1 shown unassembled.

FIG. 3 is a perspective view of the gardening barrier system of FIG. 1 showing a 90 degree angle between panels when assembled, in accordance with an embodiment of the present invention.

FIG. 4 is a perspective view of the gardening barrier system of FIG. 1 showing panels in a coplanar arrangement when assembled, in accordance with an embodiment of the present invention.

FIG. 5 is a perspective view of the gardening barrier system of FIG. 1 from a back side, in accordance with an embodiment of the present invention.

FIG. 6 is a flow diagram of a method in accordance with an embodiment of the present invention.

### DETAILED DESCRIPTION OF THE INVENTION

Definitions

In describing and claiming the present invention, the following terminology will be used in accordance with the definitions set forth below.

The singular forms “a,” “an,” and, “the” include plural referents unless the context clearly dictates otherwise. Thus, for example, reference to “a panel” includes reference to one or more of such panels, and reference to “the attachment” includes reference to one or more of such attachments.

As used herein, the term “about” is used to provide flexibility to a numerical range endpoint by providing that a given value may be “a little above” or “a little below” the endpoint.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The Invention

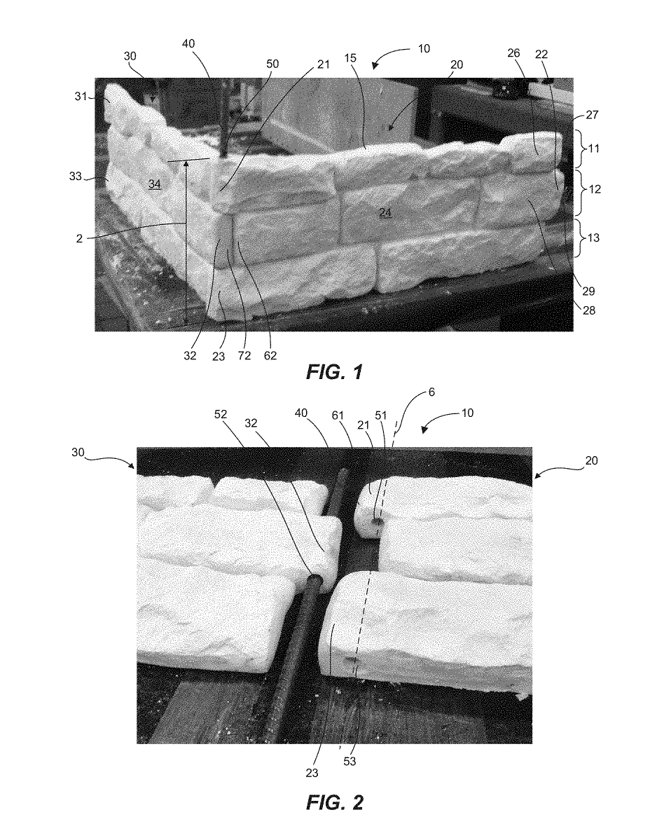

The present invention relates to a gardening barrier system and associated methods. With reference to FIG. 1, illustrated is a perspective view of an embodiment of a gardening barrier system 10. The barrier system may include a first panel 20 and a second panel 30. The panels 20, 30 may be held or secured together by a connecting rod 40. The gardening barrier system 10 may be used to provide a barrier for a variety of purposes. For example, the gardening barrier system 10 may be used as an area divider, to separate a garden or flowers from a yard space. Such applications may subject the gardening barrier system to minimal loads, if any. On the other hand, the gardening barrier system 10 may be used as a planter box or a retaining wall. These applications may require the gardening barrier system 10 to contain soil, rocks, or other types of earth, which can subject the gardening barrier system to higher loads. For such uses, the gardening barrier system 10 may be designed to withstand forces that may be encountered in these applications. In some aspects, the various components or elements of a gardening barrier system 10, such as a panel and a connecting rod, can be configured to withstand a distributed lateral load acting on a single panel of up to about 1000 pounds. In one aspect, a panel of a barrier system can be straight, curved, angled, or any combination thereof in order to serve a particular purpose.

The gardening barrier system 10 may be constructed of a material having sufficient strength to withstand higher loads from planter box or retaining wall applications. Moreover, the panels 20, 30 may be formed using a mold to achieve a desired shape and/or decorative facade. Accordingly, panels 20, 30 of the gardening barrier system 10 are typically constructed from an aggregate material. “Aggregate” is a collective term for sand, gravel and crushed stone mineral materials in their natural or processed state. An aggregate material may include aggregate and a binder, such as cement. An aggregate material may also include reinforcing elements such as fibers, bars, grids, plates, netting, webbing, or any other reinforcement configuration. Reinforcing elements may be made of glass, metal, carbon, wood, polymers, textiles, or any other natural or synthetic reinforcement material. In a particular embodiment, an aggregate material may be glass fiber reinforced concrete (GFRC). Thus, aggregate material can provide the necessary strength for the high loads that a planter box or retaining wall may require, as well as being formable into a desired shape and/or decorative façade.

Traditionally, wall building materials included natural materials such as rock, wood, brush, thatch, grass, etc. Another traditional wall building material is man-made brick. Often, walls constructed of rock, brick, or wood have a mortar material that binds individual pieces together to give strength to the wall structure. Many people find walls constructed of these wall building materials to be aesthetically appealing.

As mentioned above, the panels 20, 30 of the gardening barrier system 10 may be formed in a mold to achieve a desired shape. In one aspect, due to high loads that the panels may experience, the panels can be formed as solid structures, as opposed to hollow structures. The panels 20, 30 may be formed to resemble wall building materials such as rock, brick, wood, brush, thatch, grass, etc. For example, a desired shape may be manifest on display sides 24, 34 of panels 20, 30, respectively. A display side may include surfaces of the panels that are configured to be viewed once the gardening barrier system is assembled and in place. For example, display sides 24, 34 may be visible on an outer side of a planter box or retaining wall. The display side 24 may also include a top surface 15 of the panel 20, as well. The design of the wall building materials of the façade may include a natural material, such as the rock shown in the figures. Individual pieces of the wall may be uniform or non-uniform in size or shape. In some embodiments, the natural material may be rock, wood, brush, thatch, grass, individually or in any combination. Accordingly, aggregate material can be formed to resemble natural materials or assembled natural materials. In other embodiments, the façade may include a design that depicts a mortar material between the pieces of the wall building materials. Thus, the display sides 24, 34 of the gardening barrier system 10 can resemble a wall constructed of traditional natural and man-made wall building materials.

As shown in the figures, the display side 24, 34 may include a façade resembling a wall of vertically stacked and offset pieces of one or more wall building materials. The façade depicted in the figures illustrates a rock wall having three layers 11, 12, 13 of rock. As is common in wall construction, the layers 11, 12, 13 are offset, in that at least one vertical edge 27 of an individual piece 26 in one layer does not line up with a vertical edge 29 of an adjacent individual piece 28 in an adjacent layer. Layers may or may not have the same number of pieces in each layer. For example, in the figures, layer 11 is shown as having four pieces, layer 12 is shown as having three pieces, and layer 13 is shown as having two pieces. Thus, the façade may resemble a wall of vertically stacked and offset pieces of rock arranged in a plurality of layers and there may be no limitation on the configuration of the layers or the combination of layers.

Notably, the transition between one panel and another is minimally visible, or invisible, and the panel system appears to be one continuous wall. This is in part due to the offset configuration of the materials in the façade and also in part to the overall pattern of materials. The placement of these elements works in cooperation with the vertically overlapping protrusions of the panels. As shown in FIG. 1, such vertically overlapping protrusions form a “tongue-in-groove” arrangement with two protrusions on one panel vertically overlapping with a single protrusion on another panel, which fits therebetween. Notably, any number or arrangement of vertical protrusions may be used, particularly those which mask, hide, or otherwise minimize or eliminate the visibility of the transition between panels. In one aspect, visibility of the transition between panels can be minimized or eliminated for at least the display or façade side of the panel.

With reference to FIG. 2 and continued reference to FIG. 1, the panels 20, 30 of the gardening barrier system 10 may each include protrusions resembling an offset piece of the wall depicted on display sides 24, 34. For example, panel 20 may include protrusions 21 and 23 at one end of the panel and protrusion 22 at another end of the panel. Similarly, panel 30 may include protrusions 31 and 33 at one end of the panel and protrusion 32 at another end of the panel. In a particular embodiment, protrusions may resemble an offset piece of rock in a layer of the wall depicted in the façade, such as protrusion 22 of rock piece 28.

Each protrusion may include a vertical shaft such that, when assembled, a protrusion of a panel may vertically overlap a protrusion of another panel with the vertical shafts aligned to form a connecting shaft extending the entire height of the panels. In a particular example, protrusions 21, 32, and 23 may include vertical shafts 51, 52, and 53, respectively. Protrusion 21 may vertically overlap protrusion 32, which may overlap protrusion 23. Vertical shafts 51, 52, and 53 may align to form connecting shaft 50, extending the entire height 2 of the panels 20, 30.

Vertical shafts may be formed in the protrusions at the time of molding or at a later time by removing material, such as by drilling or boring. In a specific embodiment, a vertical shaft may be formed by disposing a hollow structural member, such as a pipe, in the mold. In this embodiment, the hollow structural member may impart additional strength to the protrusions in the panel, thus enhancing the gardening barrier systems ability to withstand loads that it may see in service. Vertical shafts may be any cross-sectional shape or combination of shapes suitable to house a connecting rod during assembly and in use. In the example shown, the vertical shafts 51, 52, 53 have circular-shaped cross-sections throughout, creating cylindrical-shaped interiors of the vertical shafts.

As illustrated in FIGS. 1 and 2, a protrusion, such as protrusion 21, can include a rounded end 61. The rounded end can be oriented substantially parallel to an axis 6 of the vertical shaft 51. Thus, the rounded end can allow adjacent panels to be assembled at a given angle relative to one another about the axis. In one aspect, the angle between adjacent panels can be adjusted. In a particular aspect, the rounded end permits the angle to be infinitely adjustable. The rounded end can allow for free rotation of the panels relative to one another when at least one panel is not fixed in place, for example, by a connecting rod, as discussed below. Furthermore, the rounded end can be sized to reduce or minimize the appearance of the transition between adjacent panels. For example, the rounded end can be minimally rounded and sufficient to allow relative rotation between adjacent panels to adjust the angle between adjacent panels. In one aspect, the rounded end 72 can be sized to approximate a size of a rounded edge 62 of the one or more wall building materials of the façade. For example, the wall building material of the façade can resemble cut stone with a given radius on an edge 62 of a stone block. The rounded end 72 can include approximately the same size radius as the radius on the edge 62 of the stone block formed in the façade. With similar radii on the cut stone blocks of the façade and the protrusions, the interface or transition between adjacent panels can be disguised or made less noticeable. Thus, in one aspect, the panel thickness and/or protrusion thickness perpendicular to the display side can reduce or minimize the appearance of a transition between adjacent panels. In other words, when the rounded end is sized according to a corresponding rounded edge of the façade in order to reduce the appearance of the transition between panels, the thickness of the panel and/or protrusion can follow as a result. On the other hand, the thickness of the panel and/or protrusion can be set according to structural or other design considerations, and the resulting size of the rounded end can be used to size the rounded edge of a stone of the façade. In one aspect, the rounded end of the protrusion can substantially span the thickness of the panel. In another aspect, the rounded end of the protrusion can substantially span the thickness of the protrusion. These situations can differ depending on whether the thickness of the protrusion is substantially the same as the thickness of the panel.

Such considerations as the relationship between the rounded end of the protrusion and a rounded edge of a façade feature, as discussed above, can result in a relatively narrow thickness of the panel and/or protrusion relative to the height of the panel. In one aspect, the panel can have a height to thickness ratio of between about 6:1 and about 20:1. Accordingly, an individual protrusion of a panel can be relatively thin and elongated, as illustrated by protrusion 32.

In one aspect, a panel can have a height of between about 6 inches and about 10 feet. In another aspect, a panel can have a thickness of between about 1 inch and about 20 inches. In still another aspect, a panel can have a length of between about 2 feet and about 20 feet.

Additionally, the protrusion can be sized to minimize a gap between adjacent panels when assembled. This can also reduce or minimize the appearance of the transition between adjacent panels. For example, the protrusion can extend to contact or nearly contact an adjacent panel when assembled. This can give the appearance of a stone block tightly fitting with an adjacent stone block, which can minimize the appearance of a transition between adjacent panels.

The gardening barrier system 10 may further include a connecting rod 40. The connecting rod 40 may, when assembled, extend through the connecting shaft 50, vertically transversing the overlapping protrusions 21, 32, and 23. Thus, the connecting rod 40 may secure the panels 20, 30 together. The connecting rod 40 may also be configured to extend through the connecting shaft 50 a sufficient length to secure the gardening barrier system to a ground surface (not shown), for example, by being driven into the ground surface. The connecting rod 40 may be constructed of a material of sufficient size and strength to withstand the loads that may be present in planter bed or retaining wall applications of the gardening barrier system 10. For example, the connecting rod may be constructed of a metal, such as steel. The connecting rod may be shaped as a bar or rod and may be solid or tubular in configuration. In a particular embodiment, the connecting rod may comprise reinforcement bar (rebar), as shown in the figures. To facilitate securing the gardening system to the ground surface, the connecting rod 40 may comprise a pointed tip to penetrate the ground and a head at an opposite end that can be driven by a hammer. In another embodiment, the connecting rod may include a screw to penetrate the ground and a head at an opposite end that can receive torque to drive the screw.

In one aspect, a gardening barrier kit can include plurality of panels and at least one connecting rod to couple the plurality of panels to one another. For example, a kit can include four panels and four connecting rods such that a rectangular enclosure can be formed by a gardening barrier system formed by the elements of the kit. Of course, a kit need not include panels and connecting rods sufficient to form an enclosure and may contain any combination of panels and connecting rods.

In another aspect, adjacent panels can include matching or corresponding facades that are similar in appearance. In another aspect, adjacent panels can include non-matching facades that differ in appearance. In either case, the panels or, in particular, the protrusions of the panels can be configured to minimize visibility of the transition between the adjacent panels.

In still another aspect, panel can include a protrusion on only one end. For example, the panel can be configured as an end piece, such that the panel is intended to couple to an adjacent panel at only one end while having no protrusion or coupling feature at an opposite end. This type of panel can be useful at the end of a fence formed by the gardening barrier system, for example.

The gardening barrier system 10 is illustrated with two panels in the figures. It is to be understood that the number of panels that may be connected together in a gardening barrier system has no theoretical limit and may only be limited by practical considerations, such as space constraints or expense. Thus, a gardening barrier system may include as many panels and connecting rods as are needed for a particular application. Furthermore, panels can have nearly any length, height, and width dimensions required for a particular application or in order to attain a specific visual appeal. Moreover, the offset pieces may be any number of rows above two in number. In some aspects there may be two rows. In another aspect, there may be three rows. In yet another aspect, there may be four rows or even more depending on the desired height and overall design of the panels. In one aspect, one panel can be stacked on top of another panel to increase the height of a barrier wall. In this case, a bottom side of one panel can be configured to mate or engage with a top side of another panel to increase stability and/or enhance the appearance of the stacked panels.

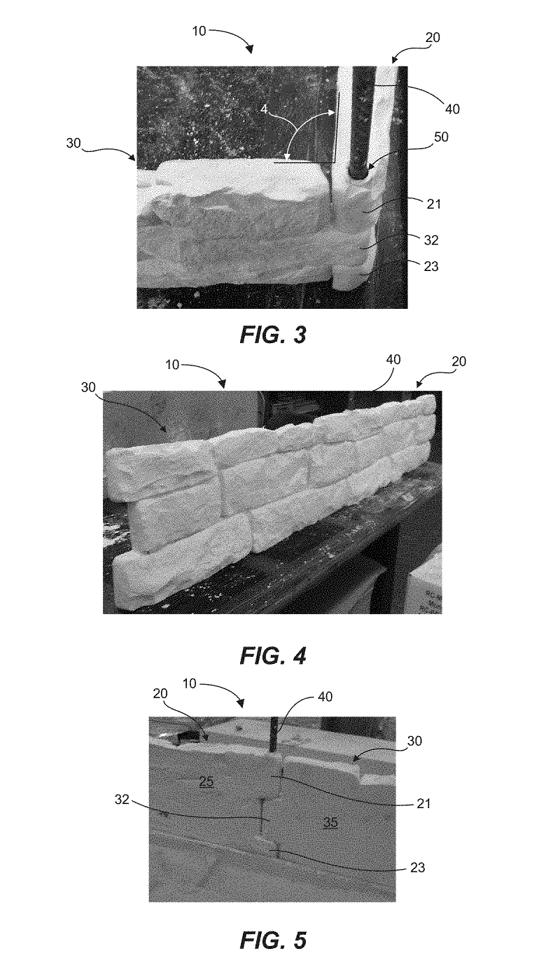

Additionally, the panels 20, 30 may be arranged at various angles with respect to one another. In other words, the connecting rods and the protrusions may form joints that allow rotation such that the panels may be disposed at any desired angle relative to one another. Once disposed at a given angle, the panels may be secured to a ground surface with the connecting rods, thus fixing the angles and preventing any further rotation. In a specific example, as shown in FIG. 1, the panels 20, 30 of gardening barrier system 10 may be at about 90 degrees relative to each other. This can be seen in another view, shown in FIG. 3, which illustrates an angle 4 between panels 20, 30 that is approximately 90 degrees. Thus, in some embodiments of the gardening barrier system 10, the angle between any two panels may be 90 degrees when assembled, as measured about the connecting rod 40. In another specific example, shown in FIG. 4, any two panels of the gardening barrier system 10 may be at about a 180 degree angle relative to each other when assembled, as measured about the connecting rod 40. In other words, two or more panels may be coplanar with one another when assembled. In the preceding examples, the panels were disposed at angles of 180 degrees or less relative to one another. In some embodiments (not shown), the gardening barrier system may include panels disposed at angles of greater than 180 degrees relative to one another when assembled. In a particular example of this, two panels may be disposed at a 270 degree angle relative to one another when assembled. This may be done to create a desired visual effect, follow a particular terrain, or to create an enclosure of a desired shape. Furthermore, it is possible to rotate the panels into nearly any angular relationship about the connecting rod that within either +90 degrees or −90 degrees from the 180 degree relationship (i.e. straight panel configuration. In some embodiments, the rotation may even be up to +/−120 degrees. Thus, in one aspect, an angle between two panels is between about 60 degrees and about 300 degrees when assembled. In a particular aspect, the angle between two panels is between about 80 degrees and about 280 degrees when assembled. In a more particular aspect, the angle between two panels is between about 90 degrees and about 270 degrees when assembled.

With reference to FIG. 5, shown is a view of a back side of a panel of the gardening barrier system 10. Specifically, back sides 25, 35 of panels 20, 30, respectively, are shown. In the figure, back sides 25, 35 are illustrated as being substantially flat, unlike the display sides, which have a façade resembling a wall of stacked building materials. In another aspect, the back side of a panel can include beams, trusses, or some other support to strengthen or reinforce the panel to strengthen or increase load capacity of the panel. Such embodiments may be used as a retaining wall, planter bed, or some other application where the back sides of the panels may be covered by earth or made less visible in some way. Alternatively, a panel may have a back side that includes a façade resembling a wall of vertically stacked and offset pieces of one or more wall building materials, similar to the display side. In a particular aspect of this embodiment, the vertically stacked and offset pieces of the back side may correspond to the vertically stacked and offset pieces of the display side. This may give the appearance, from either side, of a wall of stacked building materials. This embodiment may be used where the gardening barrier system functions as an area divider, to separate a garden or flowers from a yard space, or some other application where the back sides of the panels may be visible. In certain embodiments of gardening barrier systems, panels with back sides having façades may be combined with panels that do not have façades on the back sides in order to customize or tailor the gardening barrier system for particular needs or requirements.

In the embodiment discussed above, the gardening barrier system comprises a single vertical layer of panels. In certain other embodiments, a gardening barrier system may include the elements discussed above, but may comprise a plurality of vertical layers of panels. In these embodiments, the layers of panels may be secured together by a connecting rod that vertically transverses the connecting shaft of each vertically adjacent panel in the plurality of layers. Thus, one connecting rod may be used to secure multiple layers of vertically stacked panels together. Additionally, the connecting rods may secure the gardening barrier system to the ground surface.

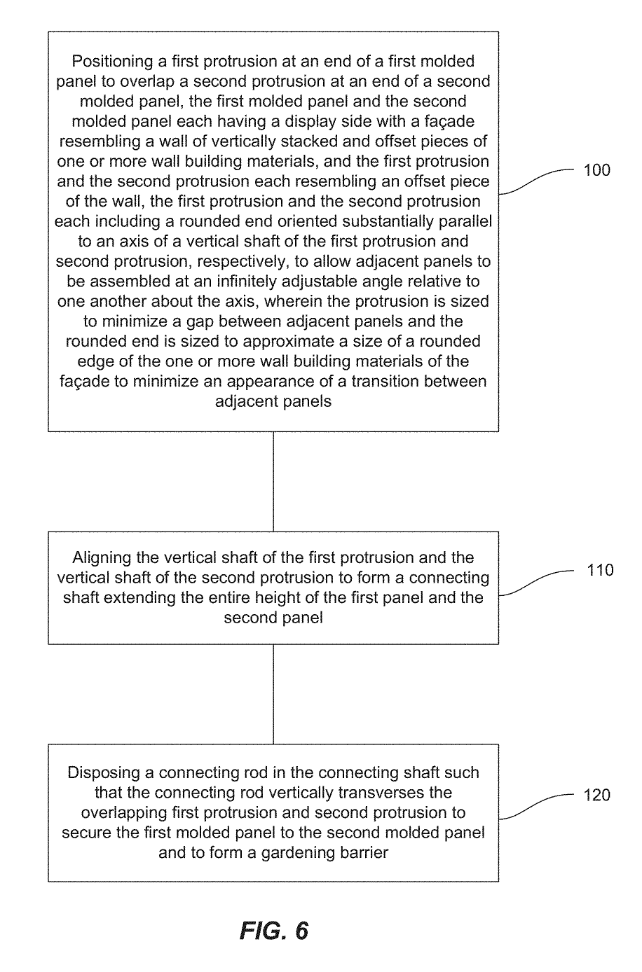

In a related embodiment, and to reiterate to some degree, a method of assembling a gardening barrier in accordance with the principles herein is shown in FIG. 6. The method comprises positioning a first protrusion at an end of a first molded panel to overlap a second protrusion at an end of a second molded panel, the first molded panel and the second molded panel each having a display side with a façade resembling a wall of vertically stacked and offset pieces of one or more wall building materials, and the first protrusion and the second protrusion each resembling an offset piece of the wall, the first protrusion and the second protrusion each including a rounded end oriented substantially parallel to an axis of a vertical shaft of the first protrusion and second protrusion, respectively, to allow adjacent panels to be assembled at an infinitely adjustable angle relative to one another about the axis, wherein the protrusion is sized to minimize a gap between adjacent panels and the rounded end is sized to approximate a size of a rounded edge of the one or more wall building materials of the façade to minimize an appearance of a transition between adjacent panels 100. The method further comprises aligning the vertical shaft of the first protrusion and the vertical shaft of the second protrusion to form a connecting shaft extending the entire height of the first panel and the second panel 110. Additionally, the method comprises disposing a connecting rod in the connecting shaft such that the connecting rod vertically transverses the overlapping first protrusion and second protrusion to secure the first molded panel to the second molded panel and to form a gardening barrier 120. It is noted that no specific order is required in this method, though generally in one embodiment, these method steps can be carried out sequentially.

In one aspect, the method further comprises securing the gardening barrier to a ground surface with the connecting rod. In another aspect, the method comprises disposing soil proximate to a back side of the first molded panel. In yet another aspect, the method further comprises positioning the first molded panel and the second molded panel at a predetermined angle relative to each other. In still another aspect, the predetermined angle may be between about 60 degrees and about 300 degrees.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A gardening barrier system, comprising:
a plurality of substantially identical molded panels made from an aggregate material, each panel having
a display side with a façade resembling a wall of vertically stacked and offset pieces of one or more wall building materials;
a protrusion at one end of the panel resembling an offset piece of a wall building material;
a protrusion at an opposite end of the panel resembling two offset pieces of a wall building material;
the protrusions each including a vertical shaft such that, when assembled, the protrusion at one end of a panel vertically overlaps the plurality of protrusions at an opposite end of a second of another panel with the vertical shafts aligned to form a connecting shaft extending substantially an entire height of the plurality of panels;
wherein the protrusions are sized to minimize a gap between adjacent panels minimize an appearance of a transition between adjacent panels; and
a connecting rod that, when assembled, extends through the connecting shaft, vertically transversing the overlapping protrusions, and secures the plurality of panels together.

2. The gardening barrier system of claim 1, wherein each panel has a height to thickness ratio of between about 6:1 and about 20:1.

3. The gardening barrier system of claim 1, wherein the wall building materials include a brick appearance.

4. The gardening barrier system of claim 1, wherein the façade includes a design depicting a mortar material between the pieces of one or more wall building materials.

5. The gardening barrier system of claim 1, wherein the plurality of molded panels each further comprise a back side.

6. The gardening barrier system of claim 5, wherein the back side does not include a façade resembling a wall of vertically stacked and offset pieces of one or more wall building materials.

7. The gardening barrier system of claim 1, wherein two of the plurality of molded panels are coplanar with each other when assembled.

8. The gardening barrier system of claim 1, wherein an angle between two of the plurality of molded panels is between about 60 degrees and about 300 degrees when assembled.

9. The gardening barrier system of claim 8, wherein the angle between two of the plurality of molded panels is between about 80 degrees and about 280 degrees when assembled.

10. The gardening barrier system of claim 9, wherein the angle between two of the plurality of molded panels is between about 90 degrees and about 270 degrees when assembled.
